(19) United States
(12) Patent Application Publication
(10) Pub. No.: US 2025/0135747 A1
(43) Pub. Date: May 1, 2025

(54) Polymeric Film and Method of Making Same

(71) Applicant: 3M INNOVATIVE PROPERTIES COMPANY, St. Paul, MN (US)

(72) Inventors: Stephen A. Johnson, Woodbury, MN (US); William T. Fay, Woodbury, MN (US); Atheen R. Johnson, Woodbury, MN (US); Brian R. Peterson, Glenwood City, WI (US)

(21) Appl. No.: 18/690,932

(22) PCT Filed: Sep. 6, 2022
(86) PCT No.: PCT/IB2022/058380

§ 371 Date: Mar. 11, 2024

Related U.S. Application Data
(60) Provisional application No. 63/246,840, filed on Sep. 22, 2021.

(51) Int. Cl. B32B 7/023; B29D 11/00; B29K 23/00; B29K 67/00; B32B 3/28; B32B 7/02; B32B 27/32; B32B 27/36

(52) U.S. Cl. CPC B32B 7/023; B29D 11/00788; B32B 3/28; B32B 7/02; B32B 27/32; B32B 27/36; B29K 2023/12; B29K 2067/003; B32B 2307/42

(57) ABSTRACT

A polymeric film has an orthogonal length, width and thickness. The polymeric film includes first and second substrates spaced apart along the thickness and a plurality of crumpled elements extending between the first and second substrates and along the length. The crumpled elements are substantially coextensive with the first and second substrates along the length and are spaced apart along the width.

### SUMMARY

In some aspects, the present description provides a polymeric film having an orthogonal length, width and thickness. The polymeric film includes first and second substrates spaced apart along the thickness; and a plurality of crumpled elements extending between the first and second substrates and along the length. The crumpled elements are substantially coextensive with the first and second substrates along the length and are spaced apart along the width.

In some aspects, the present description provides an integrally formed polymeric film defining a plurality of through channels therein. The channels extend along a length direction of the integrally formed polymeric film and are arranged along a width direction of the integrally formed polymeric film orthogonal to the length direction. The plurality of channels is disposed between first and second portions of the integrally formed polymeric film. The first and second portions extend substantially coextensively with the integrally formed polymeric film along the length and width directions. At least one of the first and second portions is birefringent.

In some aspects, the present description provides an integrally formed polymeric film having an orthogonal length, width and thickness. The integrally formed polymeric film includes first and second portions spaced apart along the thickness and a plurality of elements extending between the first and second portions along the length and spaced apart along the width to define a plurality of through channels extending substantially coextensively with the integrally formed polymeric film. At least one of the first and second portions being birefringent.

In some aspects, the present description provides a thermal management system that includes a polymeric film defining a plurality of through channels therein.

In some aspects, the present description provides a method for making a polymeric film extending along a length direction of the polymeric film and having a width along a width direction of the polymeric film orthogonal to the length direction. The polymeric film defines a plurality of channels therein. The channels extend along the length direction and are arranged along the width direction. The method includes extruding first and second resins through respective first and second pluralities of slots in a slot plate to form a molten stack of alternating respective first and second extended elements. Each of the first and second pluralities of slots have a flow direction angled relative to a first plane defined by the length and width directions. The first and second extended elements extend along the length direction and are tilted in a second plane orthogonal to the length direction. The method includes extruding first and second skin layers onto respective opposite first and second sides of the molten stack to form a molten film; compressing the molten film in at least a thickness direction orthogonal to the length and width directions; cooling the molten film to form a first film; and stretching the first film along at least the width direction to form the polymeric film.

These and other aspects will be apparent from the following detailed description. In no event, however, should this brief summary be construed to limit the claimable subject matter.

### BRIEF DESCRIPTION OF THE DRAWINGS

FIGS. 1-2 are schematic cross-sectional views of polymeric films, according to some embodiments.

FIGS. 3A-3B are end and top view images, respectively, of an exemplary polymeric film.

FIG. 4 is a schematic top view of a plurality of crumpled elements, according to some embodiments.

FIGS. 5A-5B are schematic top views of crumpled elements, according to some embodiments.

FIGS. 5C-5D are schematic cross-sectional views of portions of polymeric films illustrating crumpled elements, according to some embodiments.

FIG. 6 is a schematic plan view of a die for extruding a polymeric film, according to some embodiments.

FIGS. 7A-7C are schematic cross-sectional views of a slot plate, according to some embodiments.

FIG. 8A is a schematic cross-sectional view of a molten film, according to some embodiments.

FIG. 8B is a schematic cross-sectional view of a film, according to some embodiments, which may correspond to the molten film of FIG. 8A after being compressed.

FIG. 9 is a schematic illustration of a method of making a polymeric film, according to some embodiments.

FIG. 10 is a schematic illustration of stretching a film along at least a width direction, according to some embodiments.

FIG. 11 is a schematic end view of a slot plate, according to some embodiments.

FIG. 12 is a schematic illustration of a polymer flow path through a slot plate, according to some embodiments.

FIG. 13 is a schematic end view of a skin plate, according to some embodiments.

FIG. 14 is a bottom view image of a film prior to orientation, according to some embodiments.

FIG. 15 is a schematic cross-sectional view of a thermal management system, according to some embodiments.

### DETAILED DESCRIPTION

In the following description, reference is made to the accompanying drawings that form a part hereof and in which various embodiments are shown by way of illustration. The drawings are not necessarily to scale. It is to be understood that other embodiments are contemplated and may be made without departing from the scope or spirit of the present description. The following detailed description, therefore, is not to be taken in a limiting sense.

According to some embodiments of the present description, a polymeric film is provided that provides channels extending across a length of the film. The channels can be formed between first and second substrates and adjacent channels can be separated by elements extending along a length of the film. The substrate(s), which may also be referred to as substrate portion(s), may be portion(s) of the film that have a substantially constant thickness. The substrate(s) can be integrally formed with the elements separating adjacent channels. The elements may be or include crumpled elements. A crumpled element is an element that appears crumpled regardless of the process of making the element. For example, a crumpled element is typically irregularly wrinkled along a length and width of the element. The film can be an extruded and/or integrally formed film. A film is integrally formed if the various portions of the film are manufactured together rather than manufactured separately and then subsequently joined. It has been found, according to some embodiments, that channels can be provided in an integrally formed film by coextruding a web including a plurality of tilted extended elements disposed between two skin layers and then stretching the coextruded web. Such films have been found to be useful, for example, for transporting materials and/or energy through the film along the length of the film. For example, the channels can be used for transporting fluid through the film where the fluid can be heated or cooled so that the film can be used as a heat exchanger, for example. Such films can be useful for battery cooling, for example. Battery systems cooled using polymeric heat exchanger films are described in International Appl. Pub. No. WO 2021/044345 (Bartling et al.), for example. The films may alternatively, or in addition, be utilized as packaging films, according to some embodiments.

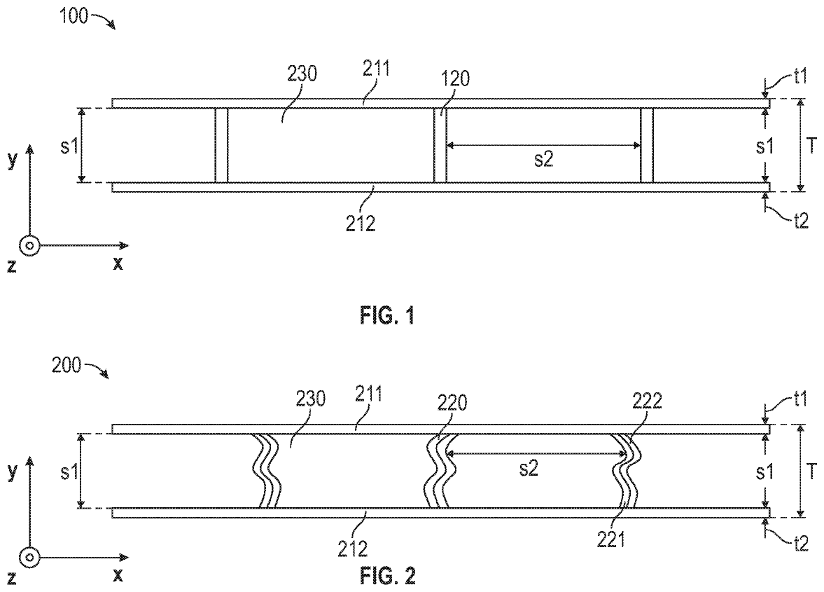

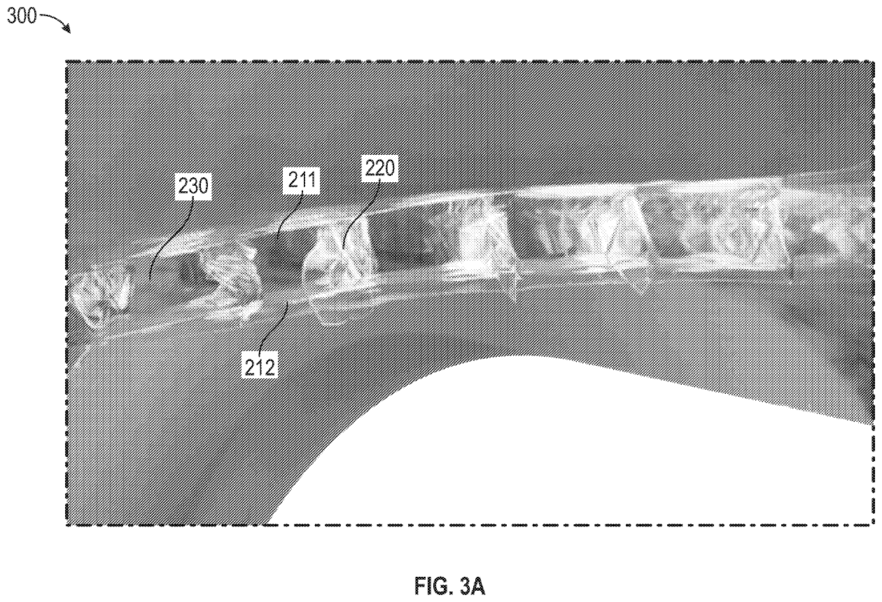

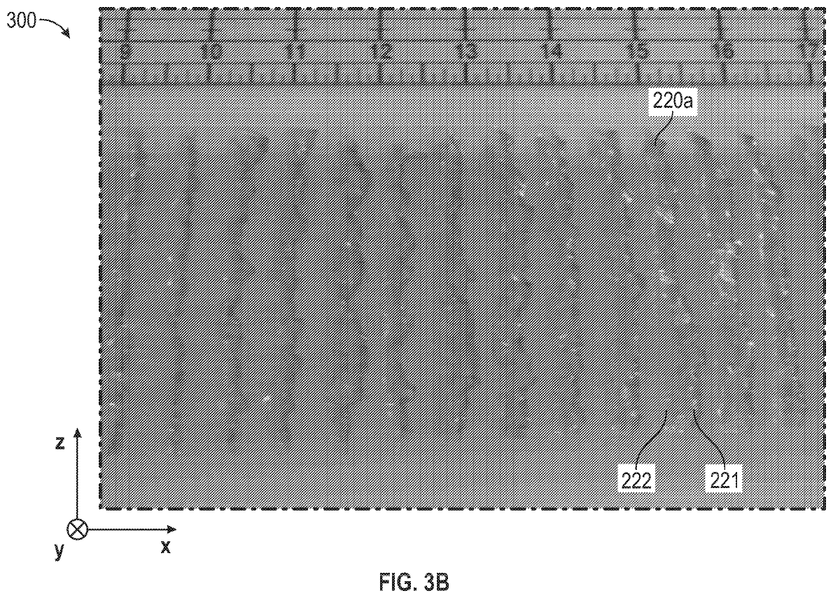

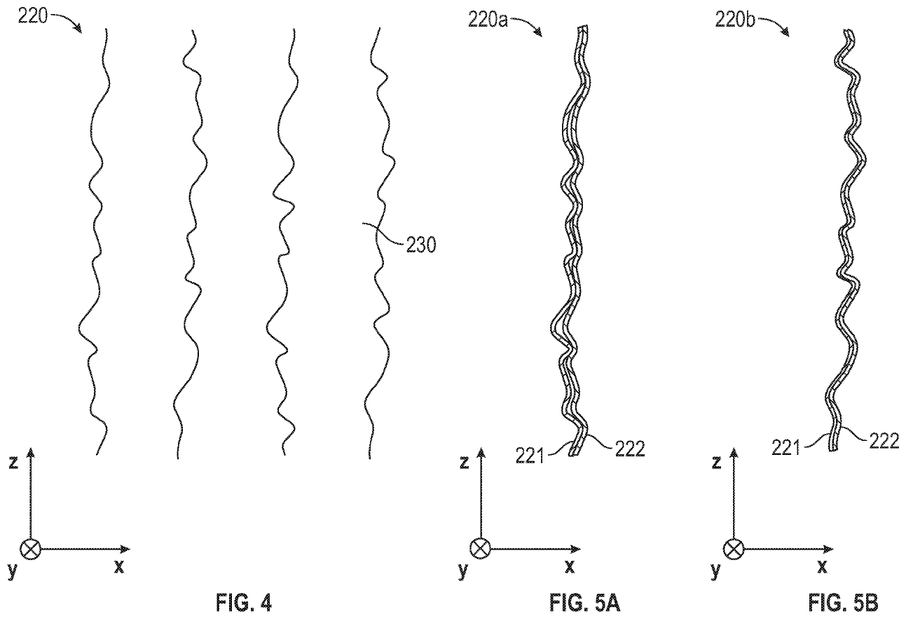

FIGS. 1-2 are schematic cross-sectional views of polymeric film 100 and 200, respectively, according to some embodiments. FIGS. 3A-3B are end and top view images, respectively, of an exemplary polymeric film 300. The polymeric film 100, 200, 300 has an orthogonal length, width and thickness. That is, the length, width and thickness are along respective length, width and thickness directions that are mutually orthogonal. The polymeric film 100, 200, 300 defines channels 230 therein, where the channels 230 extend along the length (along the length direction (z-direction) of the polymeric film) and are arranged along the width (along the width direction (x-direction) of the polymeric film which is orthogonal to the length direction). The channels 230 may be through channels. That is, the channels 230 may define continuous passageways from a first side of the film to a second side of the film opposite the first side along the length (see, e.g., FIGS. 3B and 4).

The channels 230 may be continuous channels coextensive with a length of the polymeric film 100, 200, 300. The plurality of channels 230 are disposed between first and second portions 211 and 212 of the polymeric film that each extend substantially coextensively with the polymeric film along the length and width. In some embodiments, at least one of the first and second portions 211 and 212 is birefringent, as described further elsewhere herein. In some embodiments, adjacent channels in the plurality of through channels 230 are separated by elements 120, 220 extending between the first and second portions 211 and 212 and along the length. The elements may be crumpled elements 220. As described further elsewhere herein, the crumpled elements 220 may include adjacent first and second crumpled portions extending between the first and second portions 211 and 212 and along the length. In the illustrated embodiments, adjacent channels in the plurality of channels 230 are separated by elements 120, 220 extending between the first and second portions 211 and 212 and along the length.

The polymeric film 100, 200, 300, includes first and second portions 211 and 212, which may be referred to as first and second substrates. In some embodiments, the polymeric film 200, 300 includes first and second substrates 211 and 212 spaced apart along the thickness, and a plurality of crumpled elements 220 extending between the first and second substrates 211 and 212 and along the length direction. In some embodiments, the crumpled elements 220 are substantially coextensive with the first and second substrates 211 and 212 along the length and are spaced apart along the width. The crumpled elements can include first and second crumpled portions 221 and 222 that are substantially coextensive with one another. The polymeric film 200, 300 defines a plurality of through channels 230 extending along the length therein, where adjacent through channels of the plurality of through channels are separated by a crumpled element of the plurality of crumpled elements 220. The polymeric film 100, 200, 300 may be an integrally formed polymeric film and/or may be an extruded polymeric film.

Layers or elements can be described as substantially coextensive with each other if at least about 60% by area of each layer or element is coextensive with at least about 60% by area of each other layer or element. In some embodiments, for layers or elements describes as substantially coextensive, at least about 70%, or at least about 80%, or at least about 90% by area of each layer or element is coextensive with at least about 70%, or at least about 80%, or at least about 90% by area of each other layer or element. Layers or elements can be described as substantially coextensive with each other in length and/or width if at least about 60% of the length and/or width of each layer or element is co-extensive with at least about 60% of the length and/or width of each other layer or element. In some embodiments, for layers or elements described as substantially coextensive with each other in length and/or width, at least about 80% or at least about 90% of each layer or element is co-extensive in length and/or width with at least about 80% or at least about 90% of the length and/or width of each other layer or element.

In some embodiments, an average spacing s1 between the first and second substrates along the thickness is greater than 10, 50, 100, 300, or 500 times each of an average thickness t1 of the first substrate 211 and an average thickness t2 of the second substrate 212. In some embodiments, s1 can be up to 2000 t or even up to 10,000 t where t is the larger of t1 and t2. In some embodiments, an average spacing s2 between adjacent crumpled elements along the width is greater than 10, 50, 100, 300, or 500 times each of an average thickness t1 of the first substrate 211 and an average thickness t2 of the second substrate 212. In some embodiments, s2 can be up to 2000 t or even up to 10,000 t where t is the larger of t1 and t2. In some embodiments, the channels 230 have an average height s1 along the thickness of a least 80%, 90%, 95%, 98%, 99%, or 99.5% of a thickness T of the integrally formed polymeric film. In some embodiments, the channels 230 have an average width s2 along the width of a least 0.8, 1, 1.2, or 1.5 times a thickness T of the integrally formed polymeric film. The average width s2 can be up to 10, 8, or 6 times the thickness T, for example.

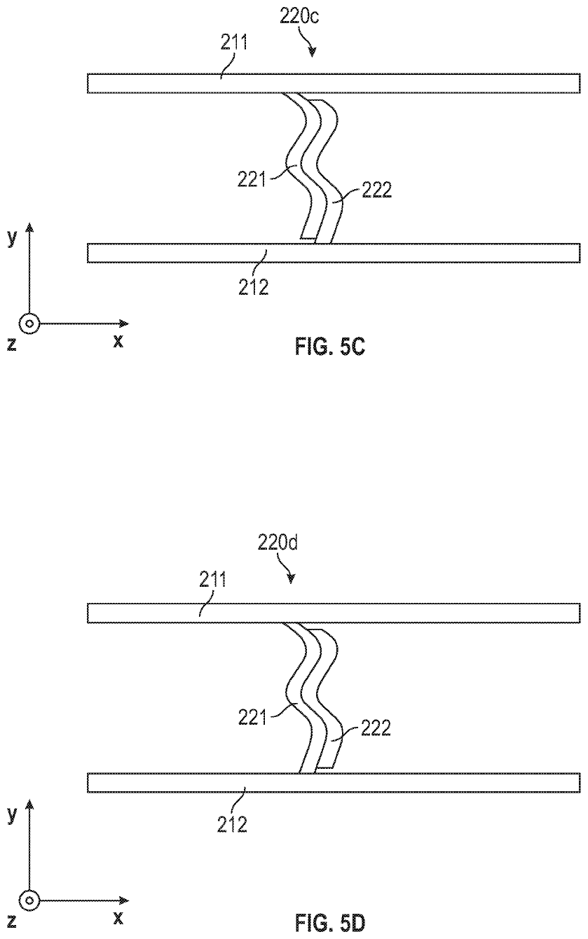

FIG. 4 is a schematic top view of a plurality of crumpled elements 220, according to some embodiments. The crumpled elements 220, and channels 230 between adjacent crumpled elements, extend along a length direction (z-direction). FIGS. 5A-5B are schematic top views of crumpled elements 220a and 220b, respectively, according to some embodiments. FIGS. 5C-5D are schematic cross-sectional views of portions of polymeric films illustrating crumpled elements 220c and 220d, respectively, according to some embodiments. The crumpled elements 220a, 220b, 220c, and 220d include first and second crumpled portions 221 and 222 that are substantially coextensive with one another. The first and second crumpled portions 221 and 222 may substantially conform (e.g., nominally conform or conform over 90% or over 95% by area) to one another as schematically illustrated in FIG. 5B or there may be separation between portions of the first and second crumpled portions 221 and 222 along substantial portions of the length of crumpled element as schematically illustrated in FIG. 5A.

In some embodiments, each crumpled element in at least a majority of the crumpled elements 220 includes a first crumpled portion 221 attached directly to at least one of the first and second substrates and a second crumpled portion 222 adjacent to the first portion. In some embodiments, the polymeric film is an integrally formed polymeric film and each crumpled element in at least a majority of the crumpled elements includes a first crumpled portion 221 attached directly to at least one of the first and second portions 211 and 212 of the integrally formed polymeric film and a second crumpled portion 222 adjacent to the first crumpled portion 221, where the first and second crumpled portions 221 and 222 are substantially coextensive with one another. Elements may be attached to one another as a result of being coextruded with one another. Elements attached together without an intervening layer (such as an adhesive layer) can be described as attached directly to one another or directly bonded together. In FIG. 5C, the first crumpled portion 221 is directly bonded to the first substrate 211 but not to the second substrate 212, while in FIG. 5D, the first crumpled portion 221 is directly bonded to each of the first and second substrates 211 and 212. In some embodiments, for each crumpled element in the at least a majority of the crumpled elements, the first and second crumpled portions 221 and 222 of the crumpled element are directly bonded to one another along at least a portion of a length the crumpled element. In some embodiments, for each crumpled element in the at least a majority of the crumpled elements, the second crumpled portion 222 of the crumpled element is not directly bonded to at least one of the first and second substrates 211 and 212. For example, in FIG. 5C, the second crumpled portion 222 is bonded to the first substrate 212 but is not directly bonded to the second substrate 211, while in FIG. 5D, the second crumpled portion 222 is not directly bonded to either of the first and second substrates 211 and 212 but is directly bonded to the first crumpled portion 221. In other embodiments, each of the first and second crumpled portions 221 and 222 is directly bonded to each of the first and second substrates 211 and 212 as schematically illustrated in FIG. 2, for example.

The bonding of the first and second crumpled portions 221 and 222 to the first and second substrates 221 and 222 can depend on the polymers used for the crumpled portions and the substrates. For example, polymers with similar monomer units tend to bond well to one another, while low surface energy polymers tend to bond weakly with other polymers not having similar monomer units. Blends of polymers or copolymers with different monomer units may be used to adjust the bonding. In some embodiments, the substrates 211 and 212 and the first crumpled portion 221 can be formed of same or different polyester compositions (e.g., polyethylene naphthalate, polyethylene terephthalate, or copolymers thereof) that bond well to one another while the second crumpled portion can be formed from an olefin composition (e.g., polypropylene), a styrenic composition (e.g., styrenic block copolymers), or a blend or mixture thereof which bonds relatively poorly with one or both of the substrates. Stretching the film may then cause the second crumpled portion 222 to detach from one or both of the substrates while the second crumpled portion 222 may remain bonded to the first crumpled portion 221 due to, for example, a contact area between the crumpled portions being sufficiently large that the crumpled portions remain bonded (see, e.g., FIG. 5D). In some embodiments, the first substrate 211 and the first crumpled portion 221 can be formed from the same or different polyester compositions, while the second substrate 212 and the second crumpled portion 222 can be formed from the same or different olefin or styrenic compositions resulting in the first crumpled portion 221 directly bonded to the first substrate 211, and the second crumpled portion 222 directly bonded to the second substrate 212 (see, e.g., FIG. 5C).

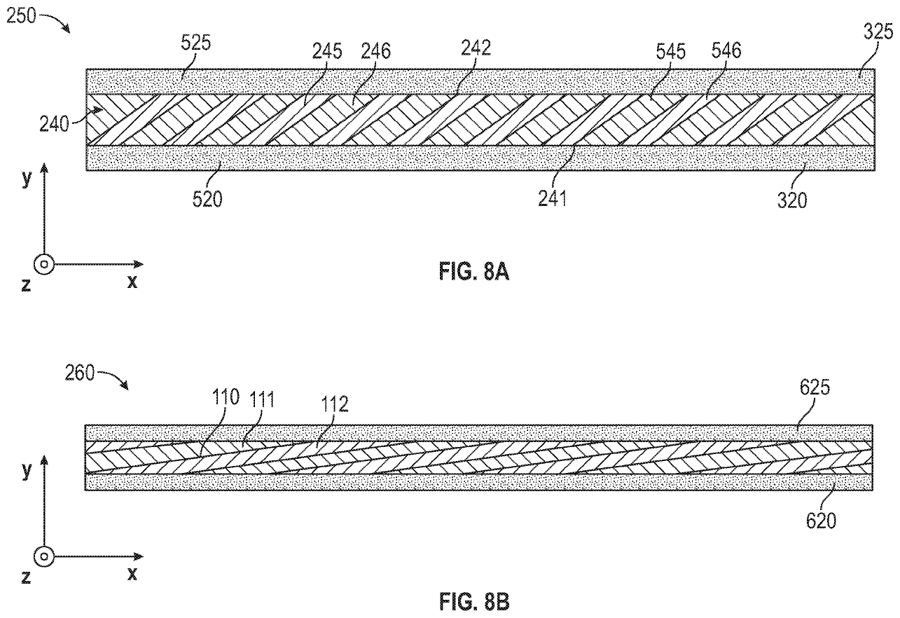

In some embodiments, the first and second crumpled portions 221 and 222 have different respective first and second compositions (e.g., corresponding to compositions 545 and 546 schematically illustrated in FIG. 8A). In some embodiments, the first substrate 211 comprises the first composition (e.g., the first substrate 211 can comprise the composition 545). In some such embodiments, or in other embodiments, the second substrate 212 comprises the second composition (e.g., the second substrate 212 can comprise the composition 546). In some embodiments, the first composition is a first polyester composition, and the first substrate 211 comprises a second polyester composition. In some such embodiments, or in other embodiments, the second composition comprises at least one of an olefin composition and a styrenic composition. In some such embodiments, or in other embodiments, the second substrate 212 comprises at least one of an olefin composition and a styrenic composition. The first and second polyester compositions can be different or can be a same polyester composition. In some embodiments, the compositions are selected such that the first and second crumpled portions 221 and 222 have surface tensions differing from one another by at least 10%, 15%, or 20%, for example. The surface tensions may differ by up to about 130%, about 100%, or about 80%, for example. Surface tensions of polymers used in the films can often be found in standard tables of surface tensions, as would be appreciated by those of ordinary skill in the art. Surface tension can be measured using contact angle measurements as described in ASTM D7490-13 “Standard Test Method for Measurement of the Surface Tension of Solid Coatings, Substrates and Pigments using Contact Angle Measurements”, for example.

In some embodiments, the compositions include thermoplastic polymers that can be selected to be readily extrudable and processable. For example, the thermoplastic polymers can be selected to have molecular weights and/or intrinsic viscosities and/or melt flow indices (MFIs) in suitable ranges for extrudability. In some embodiments, the thermoplastic polymers have a weight-averaged molecular weight Mw greater than 20,000 Daltons or greater than 35,000 Daltons, or greater than 50,000 Daltons. The weight-averaged molecular weight Mw may be up to 1,000,000 Daltons, or up to 400,000 Daltons, or up to 200,000 Daltons or up to 150,000 Daltons, for example. In some such embodiments, or in other embodiments, the thermoplastic polymers have an intrinsic viscosity in range of 0.3 dl/g to 1.2 dl/g or 0.4 dl/g to 1.0 dl/g when measured in a solvent blend comprising 60 weight percent o-chlorobenzene and 40 weight percent phenol. In some such embodiments, or in other embodiments, the thermoplastic polymers have a melt flow index greater than 5 g/10 min, or greater than 10 g/10 min, or greater than 20 g/10 min. The melt flow index may be up to 300 g/10 min, or up to 200 g/10 min, or up to 100 g/10 min, for example. The weight averaged molecular weight Mw can be determined using gel permeation chromatography, for example. The intrinsic viscosity can be determined using a capillary viscometer, for example. The melt flow index, which may alternatively be referred to as melt flow rate, can be determined using an extrusion plastometer according to ASTM D1238-20, for example.

Suitable materials for the various portions of the films of the present description include, for example, polyethylene naphthalate (PEN), coPEN (copolyethylene naphthalate terephthalate copolymer), polyethylene terephthalate (PET), polyhexylethylene naphthalate copolymer (PHEN), glycol-modified PET (PETG), glycol-modified PEN (PENG), syndiotactic polystyrene (sPS), THV (a terpolymer of tetrafluoroethylene, hexafluoropropylene and vinylidene fluoride), polymethyl methacrylate (PMMA), coPMMA (a copolymer of methyl methacrylate and ethyl acrylate), styrenic block copolymers (block copolymers including styrene blocks) such as linear triblock copolymers based on styrene and ethylene/butylene (e.g., styrene-ethylene/butylene-styrene (SEBS) copolymers), acrylic block copolymers (block copolymers including acrylate or methacrylate blocks) such as a linear triblock copolymers based on methyl methacrylate and n-butyl acrylate, anhydride-modified ethylene vinyl acetate polymers, ketone ethylene ester terpolymers, polyolefin thermoplastic elastomer, polypropylene (PP), co-polypropylene (coPP) such as copolymers of propylene and ethylene, urethanes such as thermoplastic polyurethanes (TPUs), or blends thereof.

Atactic polystyrene (aPS) can optionally be blended with sPS (e.g., at about 5 to about 30 weight percent aPS) to adjust the refractive indices of the resulting layer and/or to reduce the haze of the layer (e.g., by reducing a crystallinity of the layer). Suitable THV polymers are described in U.S. Pat. Appl. Pub. No. 2019/0369314 (Hebrink et al.), for example, and include those available under the DYNEON THV tradename from 3M Company (St. Paul, MN). In some embodiments, THV can contain about 35 to about 75 mole percent tetrafluoroethylene, about 5 to about 20 mole percent hexafluoropropylene, and about 15 to about 55 mole percent vinylidene fluoride. Suitable styrenic block copolymers include KRATON G1645 and KRATON G1657 available from KRATON Polymers (Houston, TX). Suitable acrylic block copolymers include those available under the KURARITY tradename from Kuraray Co., Ltd. (Tokyo, JP). PETG can be described as PET with some of the glycol units of the polymer replaced with different monomer units, typically those derived from cyclohexanedimethanol. PETG can be made by replacing a portion of the ethylene glycol used in the transesterification reaction producing the polyester with cyclohexanedimethanol, for example. Suitable PETG copolyesters include GN071 available from Eastman Chemical Company (Kingsport, TN). PEN and coPEN can be made as described in U.S. Pat. No. 10,001,587 (Liu), for example. Low melt PEN is a coPEN including about 90 mole percent naphthalene dicarboxylate groups based on total carboxylate groups and is also known as coPEN 90/10. Another useful coPEN is coPEN 70/30 which includes about 70 mole percent naphthalene dicarboxylate groups and about 30 mole percent terephthalate dicarboxylate groups based on total carboxylate groups. More generally, coPEN Z/100-Z may be used where coPEN Z/100-Z includes Z mole percent naphthalene dicarboxylate groups (typically greater than 50 mole percent and no more than about 90 mole percent) and 100-Z mole percent terephthalate dicarboxylate groups based on total carboxylate groups. Glycol-modified polyethylene naphthalate (PENG) can be described as PEN with some of the glycol units of the polymer replaced with different monomer units and can be made by replacing a portion of the ethylene glycol used in the transesterification reaction producing the polyester with cyclohexanedimethanol, for example. PHEN can be made as described for PEN in U.S. Pat. No. 10,001,587 (Liu), for example, except that a portion of the ethylene glycol (e.g., about 40 mole percent) used in the transesterification reaction is replaced with hexanediol. Suitable PET can be obtained from Nan Ya Plastics Corporation, America (Lake City, SC), for example. Suitable sPS can be obtained from Idemitsu Kosan Co., Ltd. (Tokyo, Japan), for example. Suitable PMMA can be obtained from Arkema Inc., Philadelphia, PA., for example. Suitable anhydride-modified ethylene vinyl acetate polymers include those available from Dow Chemical (Midland, MI) under the BYNEL tradename, for example. Suitable ketone ethylene ester terpolymers include those available from Dow Chemical (Midland, MI) under the BYNEL tradename, for example. Suitable polyolefin thermoplastic elastomers include those available from Mitsui Chemicals (Tokyo, Japan) under the ADMER tradename. Suitable coPP includes PP8650 (random copolymer of propylene and ethylene) available from Total Petrochemicals, Inc. (Houston, TX).

In some embodiments, at least one of the first and second substrates 211 and 212 is birefringent. In some embodiments, the at least one of the first and second portions is oriented primarily along the width (i.e., there can be more orientation along the width direction than along any other direction). For example, the film can be drawn more (e.g., by at least a factor of 2) in a transverse (width) direction than in a machine (length) direction. In some embodiments, one, but not the other, of the first and second substrate 211 and 212 portions is birefringent. In some embodiments, one, but not the other, of the first and second substrates is birefringent primarily along the width (x-direction) In some embodiments, one, but not the other, of the first and second substrates is uniaxially birefringent and may be uniaxially oriented along the width direction (x-direction). In some embodiments, at least one of the first and second substrates has an average birefringence greater than 0.05, 0.08. 0.1, 0.12, 0.14, 0.16, or 0.18. The average birefringence may be up to 0.3 or 0.26, for example. In some embodiments, at least one of the first and second portions 211, 212 is birefringent and may have a substantially uniform birefringence (e.g., uniaxially oriented along the width direction) of at least 0.05 or in any range described herein. The average birefringence is the birefringence averaged (unweighted mean) over locations of the layer. The birefringence at a location is the difference between the maximum and minimum refractive indices at the location. The refractive indices can be understood to be evaluated at a wavelength of 550 nm, unless indicated otherwise. The birefringence may be substantially uniform. A substantially uniform birefringence may have a standard deviation in magnitude of the birefringence of less than about 15, 10, or 5 percent of the average birefringence, for example, and may have a same principal axis (e.g., fast axis or slow axis) orientation having a standard deviation of less than about 10, 5, or 3 degrees, for example.

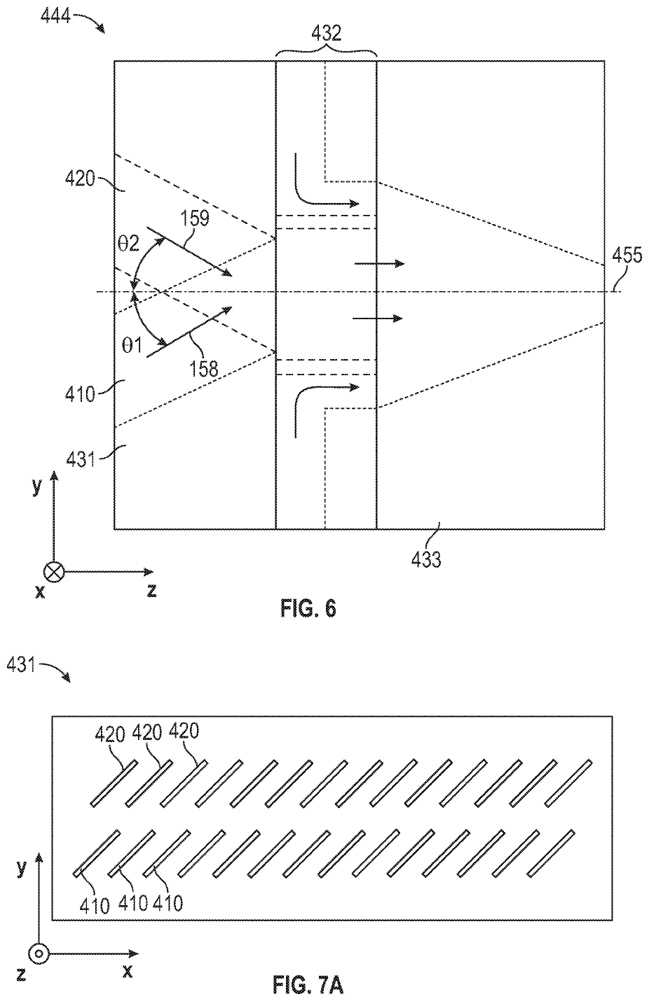

FIG. 6 is a schematic plan view of a die 444 for extruding a polymeric film, according to some embodiments. The die 444 includes a slot plate 431, skin block 432, and a compression section 433. The compression section 433 compresses the extruded web in the thickness direction (y-direction) and may optionally compress the web in the width direction (x-direction). The die 444 may include other elements which are not illustrated but are commonly used in extrusion dies, as would be appreciated by the person of ordinary skill in the art.

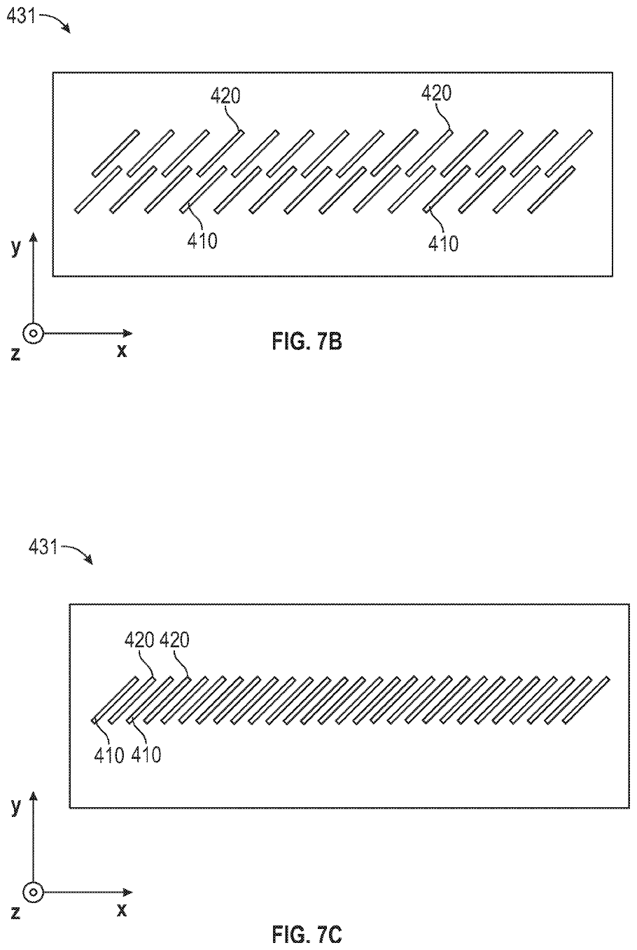

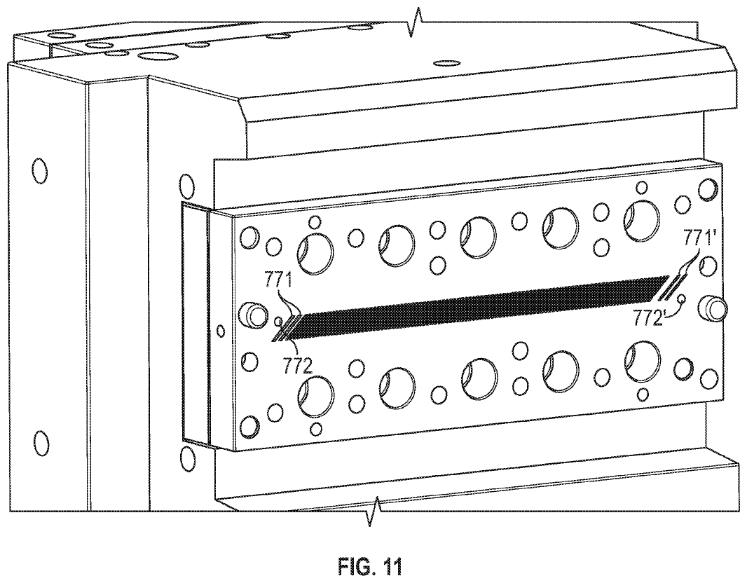

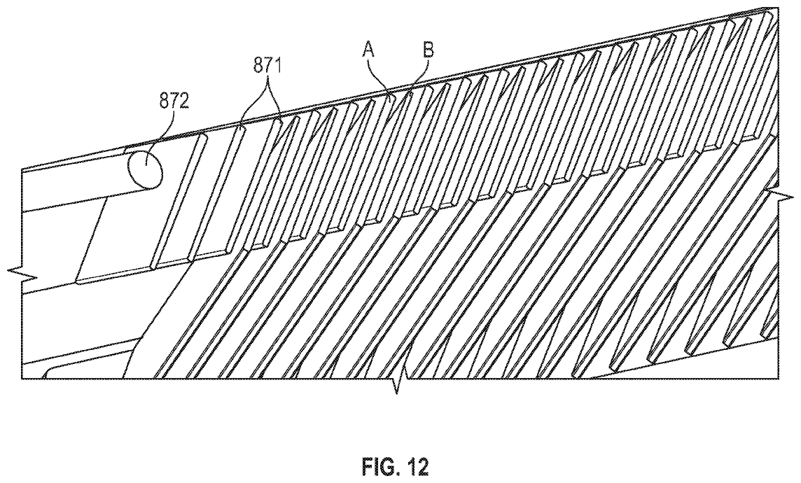

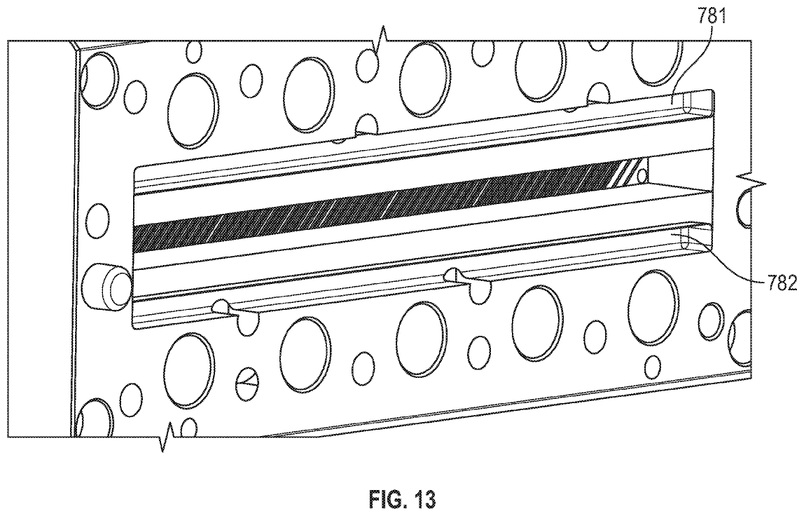

FIGS. 7A-7C are schematic cross-sectional views of the slot plate 431, according to some embodiments. FIG. 7A is a cross-section adjacent an input side of the slot plate 431, FIG. 7C is a cross-section adjacent an output side of the slot plate 431, and FIG. 7B is a cross-section between those of FIGS. 7A and 7C. The slots are schematically shown as rectangular slots in FIGS. 7A-7C but may alternatively have other shapes (e.g., to promote flow to certain areas). For example, the slots may have rounded edges or may have a generally trapezoidal shape. The slot plate 431 may include other features such as holes on opposite sides of the pluralities of slots 410, 420 to provide channels to promote flow and to fill in material in the corner regions on the sides of the pluralities of slots 410, 420. There may also be additional slots at one or both sides of the plurality of slots 410 and additional slots at one or both sides of the plurality of slots 420 that do not interlace with one another. The additional hole(s) and/or non-interlaced slot(s) may help stabilize the extruded web. As described further in the Examples, FIG. 11 is a schematic end view of a slot plate showing holes 772, 772′ and non-interlaced slots 771, 771′, according to some embodiments. FIG. 12 is a schematic illustration of polymer flow produced by the slot plate of FIG. 11, and FIG. 13 schematically illustrates the slot plate of FIG. 11 adjacent a skin plate. The slot plate 431, and other die elements, can be made using conventional machining techniques such as wire electrical discharge machining (EDM).

FIG. 8A is a schematic cross-sectional view of a molten film 250, according to some embodiments. The molten film 250 may correspond to the molten film formed by the slot plate 431 and the skin block 432 prior to being compressed in the compression section 433. The molten film 250 includes a molten stack 240 of alternating first and second extended elements 245 and 246 disposed between first and second skin layers 320 and 325. The first and second extended elements 245 and 246 have different first and second compositions 545 and 546, and the first and second skin layers 320 and 325 have third and fourth compositions 520 and 525 which may be the same or different. For example, the third and fourth compositions 520 and 525 may be a same composition which may be the same as one of the first and second compositions 545 and 546.

FIG. 8B is a schematic cross-sectional view of a first film 260, according to some embodiments. The first film 260 can correspond to the molten film 250 after being compressed in the compression section 433 and optionally being cooled. The first film 260 may be described as including a plurality of alternating first and second extended elements 111 and 112 disposed between first and second skin layers 620 and 625. The first and second extended elements 111 and 112 may be the first and second extended elements 245 and 246 after the molten film 250 is compressed and cooled to form the first film 260. Similarly, the first and second skin layers 620 and 625 may be the first and second skin layers 320 and 325 after the molten film 250 is compressed and cooled to form the first film 260.

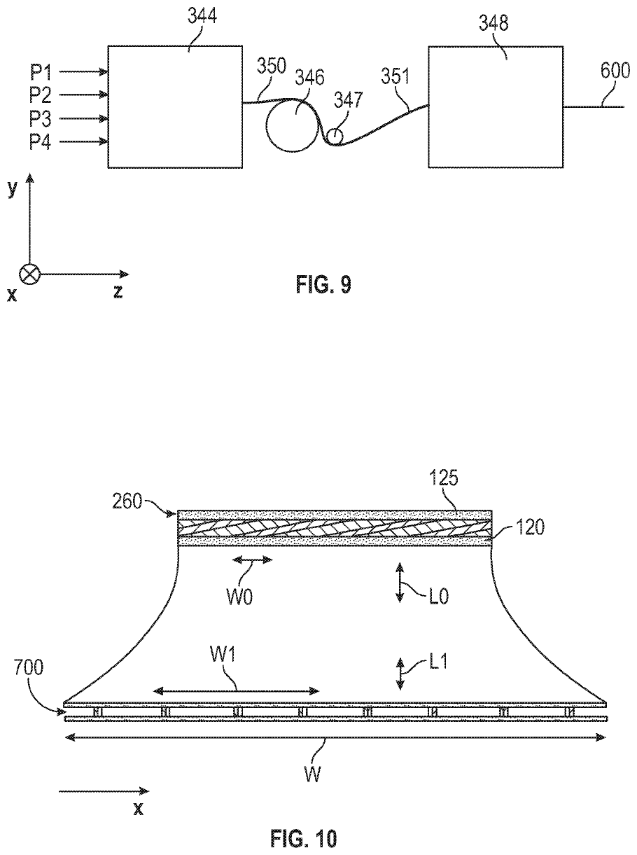

FIG. 9 is a schematic illustration of a method of making a polymeric film, according to some embodiments. Resins P1 and P2, and optionally one or both of P3 and P4, are extruded through extrusion die 344 (e.g., corresponding to die 444) to form an extruded web 350 which is cooled by casting the extruded web against a casting wheel 346 (also referred to as a chill roll) to form a cast web 351 which may correspond to first film 260. An optional roller 347 may be included and additional rollers (not shown) may optionally be included as would be appreciated by the person of ordinary skill in the art. The first and second extended elements 245 and 246 may be formed from the first and second resins P1 and P2. The first and second skin layers 320 and 325 may be formed from P1 and P2 or from any of P1 through P4. The cast web may be stretched in tenter 348 resulting in the polymeric film 600, which may correspond to polymeric film 100, 200, or 300, for example.

FIG. 10 is a schematic illustration of stretching the first film 260 along at least a width direction to form a polymeric film 700, according to some embodiments, which may correspond to any of polymeric films 100, 200, 300, or 600. The first film 260 is drawn at a first draw ratio DR1=W1/W0 in the width direction and at a second draw ratio DR2=L1/L0 in the length direction. Stretching at a substantial draw ratio in the width direction (e.g., DR1≥2, 3, 4, or 5) has been found to result in channels separated by crumpled portions as described further elsewhere herein. Stretching (contracting) at a lower DR2 draw ratio may increase the crumpling of the portions separating channels.

In some embodiments, a method is provided for making a polymeric film 100, 200, 300, 600, 700 extending along a length direction (z-direction) of the polymeric film and having a width W along a width direction (x-direction) of the polymeric film orthogonal to the length direction, where the polymeric film defines a plurality of channels 230 therein, where the channels 230 extend along the length direction and are arranged along the width direction. The method includes extruding first and second resins P1 and P2 through respective first and second pluralities of slots 410 and 420 in a slot plate 431 to form a molten stack 240 of alternating respective first (245) and second (246) extended elements 245 and 246, where each of the first and second pluralities of slots has a flow direction 158, 159 angled (01, 02) relative to a first plane (455 or xz-plane) defined by the length and width directions, and where the first and second extended elements extend along the length direction and are tilted in a second plane (yx-plane) orthogonal to the length direction; extruding (e.g., via skin block 432) first and second skin layers 320 and 325 onto respective opposite first and second sides 241 and 242 of the molten stack 240 to form a molten film 250; compressing (e.g., in compression section 433) the molten film in at least a thickness direction (y-direction) orthogonal to the length and width directions; cooling (e.g., via casting wheel 346) the molten film to form a first film 260; stretching (e.g., via tenter 348) the first film along at least the width direction to form the polymeric film.

In some embodiments, stretching the first film along at least the width direction includes drawing the first film at a draw ratio DR1 in the width direction and a draw ratio DR2 in the length direction, where 2≤DR1≤10 and DR2≤0.5 DR1. In some such embodiments, or in other embodiments, DR1 is greater than or equal to 3 times DR2 or greater than or equal to 4 times DR2. In some such embodiments, or in other embodiments, DR1 is greater than or equal to 3, 4, or 5. In some such embodiments, or in other embodiments, DR1 is less than or equal to 9, 8, or 7. DR1 can be about 6, for example, corresponding to about a 500% increase in the width of the film (e.g., W1 can be about 500% greater than W0). In some embodiments, 0.4≤DR2≤3. DR2 can be about 1, or in a range of 0.4 to 1, or in a range of 1 to 3, for example. In some embodiments, the stretching is substantially unconstrained along each of a machine direction and a thickness orthogonal to the machine and transverse directions. With unconstrained stretching, the film is allowed to contract in the machine and thickness directions while it is stretched in the transverse direction. Unconstrained stretching can be carried out using a parabolic tenter as described in U.S. Pat. No. 6,949,212 (Merrill et al.), for example.

In some embodiments, the flow direction 158, 159 of each of the first and second pluralities of slots makes an angle θ1, θ2 in a range of 5 to 85 degrees, or 10 to 90 degrees, 20 to 80 degrees, 30 to 60 degrees, or 40 to 50 degrees with the first plane. Each of the angles θ1, θ2 may be about 45 degrees, for example.

The resulting polymeric film can define a plurality of channels 230 therein as described further elsewhere herein. The channels 230 can have an average height s1 in the thickness direction of a least 80% of a thickness T of the polymeric film. The channels 230 can have an average width s2 in the width direction of a least 0.8 times a thickness of the polymeric film. s1 and s2 can be in any of the respective ranges described elsewhere herein.

In some embodiments, the first resin P1 comprises a polyester and the second resin P2 comprises an olefin. Other suitable polymers are described further elsewhere herein. In some embodiments, the first and second extended elements in the polymeric film (e.g., corresponding to portions 221 and 222 in polymeric film 200) have surface tensions differing from one another by at least 10% or in another range described elsewhere herein.

FIG. 15 is a schematic cross-sectional view of a thermal management system 1000, according to some embodiments. The thermal management system 1000 includes a pump 973 for circulating a fluid 900 through channels of a film 800 which may correspond to polymeric film 100 or 200, for example. The film 800 can be disposed on an object or device 830 which is desired to be cooled or heated. An adhesive may be disposed between the film 800 and the object or device 830 to bond the film to the object or device. Alternatively, the film 800 may include an adhesive for bonding to the object or device 830. The adhesive may be a thermally conductive adhesive (e.g., the adhesive may include thermally conductive filler). The fluid 900 may be a cooling fluid (e.g., maintained at a temperature less than a predetermined operating temperature of a device) or a heating fluid (e.g., maintained at a temperature higher than a predetermined temperature of an object). In some embodiments, a film 800 is provided that include polymeric film 100, 200 (see, e.g., FIGS. 1-2) and a liquid 900 substantially filling the channels 230 of the polymeric film.

### Examples

Films with extended elements (e.g., crumpled elements) were prepared. Physical attributes were evaluated and are shown in the following examples.

These examples are merely for illustrative purposes only and are not meant to be limiting on the scope of the appended claims. All parts, percentages, ratios, etc. in the examples and the rest of the specification are by weight, unless noted otherwise. The following abbreviations are used herein: mils=thousands of an inch, mm=millimeter, cm=centimeter, ° C.=Centigrade, sec=seconds, %=percent, in =inch, IV=intrinsic viscosity, MFI=Melt Flow Index.

TABLE 1
Materials

| Abbreviation | Description |
|---|---|
| PET | Polyethylene terephthalate, Tairilin 1N404, a 0.64 IV PET |
| | available from NanYa Plastics Corporation, Lake City SC |
| PETG | Glycol modified PET available under the tradename |
| | GN071 from Eastman Chemical Company, Kingsport, TN |
| PP | Pro-Fax SR549M, an 11 MFI polypropylene copolymer, |
| | containing 7 wt % PE. Available from LyondellBassell, |
| | Houston, TX. |
| Kraton | Kraton G1645, a Styrene-Ethylene/Butylene-Styrene |
| | block copolymer. Available from Kraton Corporation, |
| | Houston, TX. |
| MB1 | Master Batch 1, PET with 2.5% CERES Blue XR-RF dye. |
| | CERES Blue XR-RF available from Lanxess, Cologne, |
| | Germany |
| MB2 | Master Batch 2, PP with 2.5% CERES Blue XR-RF dye. |
| | CERES Blue XR-RF available from Lanxess, Cologne, |
| | Germany |
| MB3 | Master Batch 3, 0.62 IV PET compounded with 13 wt % |
| | R-101 TiO₂. TiO₂ available from Chemours, Wilmington, |
| | DE |

### Examples E1-E3 and Comparative Example C1

The hardware to form the film with a substrate portion and plurality of extended elements utilized a dual manifold die where each manifold feeds a series of slots cut in a slot plate. The slots were 0.687 inch (17.45 mm) long×0.033 inch (0.84 mm) on the wide end and 0.022 inch (0.56 mm) on the narrow end (trapezoidal shape). The slots were spaced 0.066 inch (1.68 mm) on center at the outlet side. The slots were angled in the yz-plane from the manifold to the centerline of the die and interlaced to form an ABAB . . . pattern as shown in FIG. 3. The slots were also tipped in the xy-plane (see, e.g., FIGS. 7A-7C) by 45 degrees as shown in FIG. 11. At each edge of the slot plate were several slots 771, 771′ that were not interlaced because the inlet end of the opposing slot would be beyond the feed manifold. To promote flow in the manifold and “fill in” the corner of the louver stack, a hole 772, 772′ angled in the yz-plane was drilled at each end of the slot plate. The output films have a solid band of A resin on one edge and a solid band of B resin on the other edge.

FIG. 12 shows the resultant polymer flow path through the slot plate. An AB interlaced pattern and polymer flows 871 and 872 corresponding to slots 771 and hole 772, respectively, are illustrated.

After the louver stack was formed, the resin flowed into a skin plate as shown in FIG. 13, which applied a skin layer on the top and bottom of the stack through respective channels 781 and 782. The skin layer could be the same resin as one or both of the louvers or one or two different resins. Of particular interest was when the top skin layer matches louver resin A and the bottom skin layer matches louver resin B.

The louver stack plus skins flowed to the die exit, being compressed in the y-direction from 0.50 inches (1.3 cm) high to approximately 0.050 inches (0.13 cm). The x-direction width remained constant from the slot plate to the die exit.

### Examples Preparation:

Utilizing the configuration depicted above, a series of films were produced using the following equipment set-up: The chilled roll (wheel) side skin layer was fed by a Leistritz 18 mm TSE (twin-screw extruder) which was run under vacuum and utilized a progressive temperature profile with an 8/0 temp of 260-271° C. The associated gear pump and neck tube also were heated to 260-271° C. The air side skin layer was fed by a 27 mm Leistritz (Leistritz Extrusion Technologies, Nurnberg, Germany) TSE which was run under vacuum and also utilized a progressive temp profile with an 8/0 temp at 260-271° C. The associated gear pump and neck tube also were heated to 260-271° C. Each set of the discontinuous, slanted layers were fed by a 27 mm Leistritz TSE which was run under vacuum and utilized a progressive temp profile with an 8/0 temp at 260-271° C. The associated gear pump and neck tube also were heated to 260-271° C. The die, which was described in detail above was positioned just above a 27° C. rotating chilled roll with associated electrostatic pinning for rapid web quenching. The substrates described above were produced on this equipment with cast web thicknesses 24 mils (0.61 mm) in thickness.

Table 2 shows the material composition details for the cast webs (films) produced.

TABLE 2

| Ex- | Air Side | 1^{st} Louver | 2^{nd} Louver | Chilled Roll |
|---|---|---|---|---|
| ample | Skin (A) | Portions (B) | Portions (C) | Side Skin (D) |
| E1 | 8 pound/hour | 12 pound/hour | 7.75 pound/hour | 12 pound/hour |
| | PP | PP | PETG/ | PET |
| | | | 0.25 pound/hour | |
| | | | MB1 | |
| E2 | 8 pound/hour | 13.5 pound/hour | 5.75 pound/hour | 12 pound/hour |
| | PP | PP | PETG/ | PET |
| | | | 0.25 pound/hour | |
| | | | MB1 | |
| E3 | 8 pound/hour | 7.5 pound/hour | 5.5 pound/hour | 12 pound/hour |
| | PET | PETG/ | PP/ | PP |
| | | 0.5 pound/hour | 0.5 pound/hour | |
| | | MB3 | MB2 | |

Cast web films from Example E2 were oriented on a KARO IV (Bruckner Maschinenbua GmbH and Co., Siegsdorf Germany) batch orienter using a variety of stretch ratios with a heat soak time of 60 sec, an orientation temperature of 100° C., and an orientation rate of 10%/sec. Length and width direction stretch ratios are listed in Table 3. Comparative Example C1 used Example 2 cast web, that was stretched in the length direction. The resulting films were observed for the formation of channels, crumples and the stretched film thicknesses were measured. Film thickness was measured using a Mitutoyo Absolute Digital Caliper gauge, available from Mitutoyo America Co., Aurora, IL. Properties of the resultant films are provided in Table 3. The stretch ratio in the length direction or machine direction (MD) and the stretch ratio in the width direction or transverse direction (TD) are indicated. The table indicates whether channels (gaps) were formed between adjacent extended elements and whether the fins were crumpled. The samples of the Example E2 film are labeled 2A-2F.

TABLE 3

| | | | | | Compressed |
|---|---|---|---|---|---|
| | MD Stretch | TD Stretch | | | Film |
| Sample | Ratio | Ratio | Crumples? | Gaps? | Thickness |
| 2A | 1 | 5 | No | Yes | 0.019 in |
| | | | | | (0.048 cm) |
| 2B | 0.8 | 5 | Yes | Yes | 0.132 in |
| | | | | | (0.335 cm) |
| 2C | 0.7 | 5 | Yes | Yes | 0.127 in |
| | | | | | (0.323 cm) |
| 2D | 0.6 | 5 | Yes | Yes | 0.182 in |
| | | | | | (0.462 cm) |
| 2E | 0.6 | 4 | Yes | Yes | 0.183 in |
| | | | | | (0.465 cm) |
| 2F | 0.5 | 5 | Yes | Yes | 0.205 in |
| | | | | | (0.521 cm) |
| C1 | 5 | 1 | No | No | 0.005 in |
| | | | | | (0.013 cm) |

The refractive indices of the chilled roll side skin for Example 2E were measured at 633 nm using a Metricon 2100. TD/MD/thickness direction indices were as follows: 1.671/1.586/1.527.

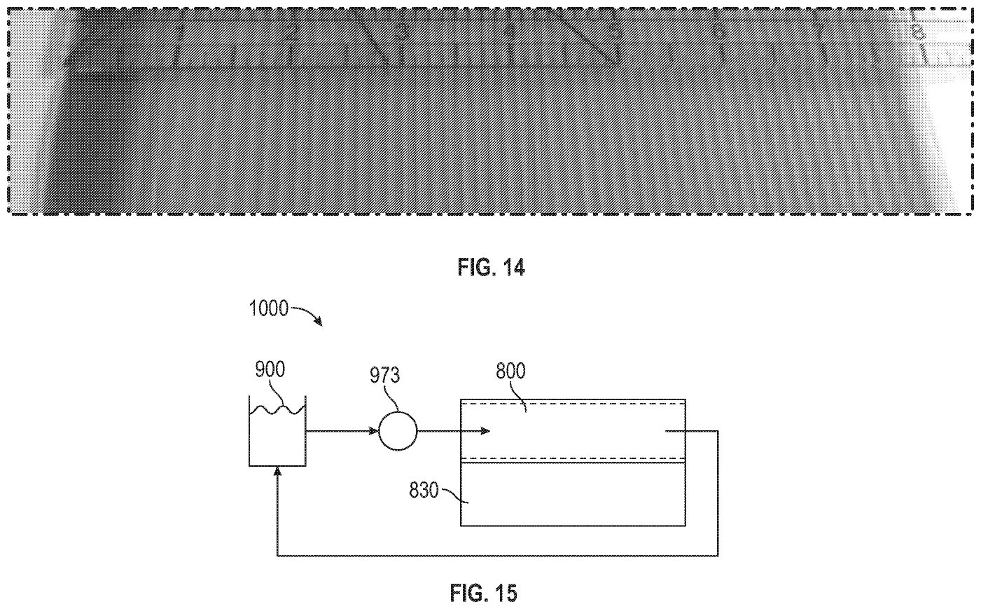

FIG. 14 is a bottom view image of Example E2 prior to orientation. A top view image appeared similar to the bottom view image. FIGS. 3A-3B are an end view image and a top view image, respectively, of Example E2C after uniaxial orientation in the transverse direction (unconstrained in the machine direction).

Terms such as “about” will be understood in the context in which they are used and described in the present description by one of ordinary skill in the art. If the use of “about” as applied to quantities expressing feature sizes, amounts, and physical properties is not otherwise clear to one of ordinary skill in the art in the context in which it is used and described in the present description, “about” will be understood to mean within 10 percent of the specified value. A quantity given as about a specified value can be precisely the specified value. For example, if it is not otherwise clear to one of ordinary skill in the art in the context in which it is used and described in the present description, a quantity having a value of about 1, means that the quantity has a value between 0.9 and 1.1, and that the value could be 1.

All references, patents, and patent applications referenced in the foregoing are hereby incorporated herein by reference in their entirety in a consistent manner. In the event of inconsistencies or contradictions between portions of the incorporated references and this application, the information in the preceding description shall control.

Descriptions for elements in figures should be understood to apply equally to corresponding elements in other figures, unless indicated otherwise. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations, or variations, or combinations of the specific embodiments discussed herein. Therefore, it is intended that this disclosure be limited only by the claims and the equivalents thereof.

1. A polymeric film having an orthogonal length, width and thickness, the polymeric film comprising:
first and second substrates spaced apart along the thickness; and
a plurality of crumpled elements extending between the first and second substrates and along the length, the crumpled elements substantially coextensive with the first and second substrates along the length and spaced apart along the width.

2. The polymeric film of claim 1, wherein each crumpled element in at least a majority of the crumpled elements comprises a first crumpled portion attached directly to at least one of the first and second substrates and a second crumpled portion adjacent to the first portion, the first and second crumpled portions substantially coextensive with one another and having different respective first and second compositions.

3. The polymeric film of claim 2, wherein the first substrate comprises the first composition.

4. The polymeric film of claim 2, wherein the second substrate comprises the second composition.

5. The polymeric film of claim 1 defining a plurality of through channels extending along the length therein, adjacent through channels of the plurality of through channels being separated by a crumpled element of the plurality of crumpled elements.

6. The polymeric film of claim 1, wherein at least one of the first and second substrates is birefringent.

7. The polymeric film of claim 1, wherein an average spacing between the first and second substrates along the thickness is greater than 10 times each of an average thickness of the first substrate and an average thickness of the second substrate.

8. The polymeric film of claim 1, wherein an average spacing between adjacent crumpled elements along the width is greater than 10 times each of an average thickness of the first substrate and an average thickness of the second substrate.

9. An integrally formed polymeric film having an orthogonal length, width and thickness, the integrally formed polymeric film comprising first and second portions spaced apart along the thickness and a plurality of elements extending between the first and second portions along the length and spaced apart along the width to define a plurality of through channels extending substantially coextensively with the integrally formed polymeric film, at least one of the first and second portions being birefringent.

10. The integrally formed polymeric film of claim 9, wherein the at least one of the first and second portions has a substantially uniform birefringence of at least 0.05.

11. The integrally formed polymeric film of claim 9, wherein the at least one of the first and second portions is oriented primarily along the width.

12. The integrally formed polymeric film of claim 9, wherein the elements comprise crumpled elements.

13. The integrally formed polymeric film of claim 12, wherein each crumpled element in at least a majority of the crumpled elements comprises a first crumpled portion attached directly to at least one of the first and second portions of the integrally formed polymeric film and a second crumpled portion adjacent to the first crumpled portion, the first and second crumpled portions substantially coextensive with one another and having different respective first and second compositions.

14. A method for making a polymeric film extending along a length direction of the polymeric film and having a width along a width direction of the polymeric film orthogonal to the length direction, the polymeric film defining a plurality of channels therein, the channels extending along the length direction and arranged along the width direction, the method comprising:
extruding first and second resins through respective first and second pluralities of slots in a slot plate to form a molten stack of alternating respective first and second extended elements, each of the first and second pluralities of slots having a flow direction angled relative to a first plane defined by the length and width directions, the first and second extended elements extending along the length direction and being tilted in a second plane orthogonal to the length direction;
extruding first and second skin layers onto respective opposite first and second sides of the molten stack to form a molten film;
compressing the molten film in at least a thickness direction orthogonal to the length and width directions;
cooling the molten film to form a first film; and
stretching the first film along at least the width direction to form the polymeric film.

15. The method of claim 14, wherein stretching the first film along at least the width direction comprises drawing the first film at a draw ratio DR1 in the width direction and a draw ratio DR2 in the length direction, wherein 2≤DR1≤10 and DR2≤0.5 DR1.
